(19) United States
(12) Patent Application Publication
(10) Pub. No.: US 2003/0182296 A1
(43) Pub. Date: Sep. 25, 2003

(54) Association candidate generating apparatus and method, association-establishing system, and computer-readable medium recording an association candidate generating program therein

(75) Inventors: Akira Sato, Kawasaki (JP); Seishi Okamoto, Kawasaki (JP); Hiroya Inakoshi, Kawasaki (JP); Toru Ozaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/282,074

(22) Filed: Oct. 29, 2002

(30) Foreign Application Priority Data
Mar. 19, 2002 (JP) 2002-076578

(51) Int. Cl. G06F 7/00

(52) U.S. Cl. 707/100

(57) ABSTRACT

The association candidate generating apparatus easily generates an association candidate for use in associating attributes (information) stored in separate information sources. The apparatus includes: a means for obtaining attributes, one from each information source; a means for calculating a degree of similarity among the attributes obtained by the obtaining means; a means for extracting, as the association candidate, a set of attributes which are assumed to be equivalent to one another, according to the degree of similarity among the last-named attributes, which similarity degree has been obtained by the calculating means; and a means for outputting the set of attributes, which has been extracted by the extracting means.

### BACKGROUND OF THE INVENTION

1. Field of the Invention

The present invention relates to an apparatus and a method suitable for use in generating association candidates for associating attributes (information) separately stored in two or more information sources which are to be linked/integrated as in EAI (Enterprise Application Integration). The invention also relates to an association-establishing system and a computer-readable recording medium in which an association candidate generating program is stored.

2. Description of the Related Art

In so-called information integration and contents management, where two or more information sources (for example, information systems or the like) are linked or integrated, information (attributes) separately stored in the information sources should be associated with one another (this process will be also called “attribute association” or simply, “association”).

Generally speaking, when information systems of a corporation are integrated, items of information managed in separate information systems are associated with one another, while leveraging the corporation's existing system investment; retaining relationship with external information which are outside the corporation's control; and modifying a once constructed information system into another form according to changes in the corporation's organization, changes of circumstances surrounding the corporation, and vision-up of the systems.

As a technique for associating (linking) such distributed information, there have been developed an adapter for absorbing differences between information-accessing methods, a network system for accessing distributed information, and a support tool for carrying out mapping between information contents.

For example, EAI (Enterprise Application Integration) is a technique for associating/integrating intra- and inter-enterprise information systems. The EAI realizes the combining and the uniting of varying systems used in a single company, and it also realizes the combining of information systems which becomes necessary with inter-enterprise electronic commerce such as B to B (Business to Business) commerce.

FIG. 5 is an example of a screen image of a conventional association-establishing apparatus. This example shows a screen image of a support tool which maps (associates/links) contents (attributes) each stored in separate information systems. In FIG. 5, attributes composing an inventory control system installed in a factory of manufacturer A are to be associated with attributes composing a physical distribution system of the manufacturer A.

As shown in FIG. 5, in the physical distribution system (see the right part of FIG. 5), there is provided an item “television” under an item “category,” and also, there are provided items, “Hi-Vision TV,” “wide-screen TV,” and “ordinary screen TV,” under the item “television.” In the meantime, in the inventory control system (see the left part of FIG. 5), there is provided an item “TV SET” under an item “category,” and also, there are provided items, “TV,” “HDTV,” and “WTV,” under the item “TV SET.”

The contents of the items, “category,” “television,” “Hi-Vision TV,” “wide-screen TV,” “ordinary screen TV” of the physical distribution system are considered to be the same or approximately the same as the contents of the items, “category,” “TV SET,” “TV,” “HDTV,” and “WTV,” of the inventory system, respectively.

When linking/integrating those inventory system and physical distribution system on a screen image (see FIG. 5) of an association-establishing apparatus, a user (for example, a system administrator) selects items of the inventory system and those of the physical distribution system one by one, which items are considered to be able to be linked each other, and then connects (links/associates) the selected items with a line. In this manner, the linking of the items is carried out with a graphical presentation. Hence, the user can carry out such linking operations visually, without writing a program, so that the linking operations can be facilitated.

In this manner, the two information systems (the physical distribution system and the inventory system) are associated with each other, thereby allowing the two different systems to operate as if they were one single system.

Such a conventional associating method, however, is on the assumption that a user has a detailed knowledge of the relationships among the information items (attributes) in the information systems.

That is, it is required for the user to previously investigate/check system specifications of the information systems to be associated with each other. There is thus raised a problem that such investigation/checking is increasingly time-consuming and cost-taking, with recent increase in the amount of information to be managed and the sizes of the systems.

Moreover, the above associating processing should be performed more than once; it should be carried out as occasion arises, in accordance with changes in external circumstances to the system and in the corporation organization, and version-up of the system. In addition, it is desired that adaptability to the change of the quality of information itself is also realized.

### SUMMARY OF THE INVENTION

With the foregoing problems in view, one object of the present invention is to provide an apparatus and a method suitable for use in generating association candidates for associating attributes (information) separately stored in two or more information sources which are to be linked/integrated.

Another object of the invention is to provide a computer-readable recording medium storing an association candidate generating program.

A further object of the invention is to provide an association-establishing system which facilitates the associating processing.

In order to accomplish the above objects, according to the present invention, there is provided an apparatus for generating an association candidate for use in associating a plurality of information sources each storing entities, each entity storing one or more attributes. The apparatus comprises: means for obtaining attributes, one from each of the plurality of information sources; means for calculating a degree of similarity among the attributes which have been obtained by the obtaining means; means for extracting, as the association candidate, a set of attributes which are assumed to be equivalent to one another, according to the degree of similarity among the last-named attributes, which similarity degree has been obtained by the calculating means; and means for outputting the set of attributes, which has been extracted by the extracting means.

As a preferred feature, the calculating means calculates the degree of similarity among the attributes, based on their likeness in designations given to the attributes. Further, the calculating means calculates the degree of similarity among the attributes, based on their likeness in terms of distribution of attribute values stored in the attributes.

As another preferred feature, the calculating means calculates the degree of similarity among the attributes, based on their likeness in terms of distribution of character elements constituting attribute values stored in the attributes. Further, the calculating means calculates the degree of similarity among the attributes, based on their likeness in terms of distribution of string lengths of attribute values stored in the attributes.

As still another preferred feature, the apparatus further comprises preprocessing means for performing predetermined preprocessing before the calculating means calculates the degree of similarity among the attributes.

As a generic feature, there is provided a method for generating an association candidate for use in associating a plurality of information sources each storing entities, each entity storing one or more attributes. The method comprises the steps of: obtaining attributes, one from each of the plurality of information sources; calculating a degree of similarity among the attributes which have been obtained in the obtaining step; extracting, as the association candidate, a set of attributes which are assumed to be equivalent to one another, according to the degree of similarity among the last-named attributes, which similarity degree has been obtained in the calculating step; and outputting the set of attributes, which has been extracted by the extracting step.

As another generic feature, there is provided a system for associating a plurality of attributes, each being stored separately in one of a plurality of information sources, each of which stores entities, each entity storing one or more attributes. The system comprises: means for obtaining attributes, one from each of the plurality of information sources; means for calculating a degree of similarity among the attributes which have been obtained by the obtaining means; means for extracting, as the association candidate, a set of attributes which are assumed to be equivalent to one another, according to the degree of similarity among the last-named attributes, which similarity degree has been obtained by the calculating means; means for outputting the set of attributes, which has been extracted by the extracting means; and means for associating the set of attributes, which has been output by the outputting means.

As still another generic feature, there is provided a computer-readable recording medium which stores a program for generating an association candidate for use in associating a plurality of information sources, each storing entities, each entity storing one or more attributes. The program instructs a computer to function as the following: means for obtaining attributes, one from each of the plurality of information sources; means for calculating a degree of similarity among the attributes which have been obtained by the obtaining means; means for extracting, as the association candidate, a set of attributes which are assumed to be equivalent to one another, according to the degree of similarity among the last-named attributes, which similarity degree has been obtained by the calculating means; and means for outputting the set of attributes, which has been extracted by the extracting means.

The association candidate generating apparatus and method, the association-establishing system, and the computer-readable medium recording an association candidate generating program, of the present invention, guarantee the following advantageous results.

(1) The similarity among attributes (information) each stored in separate information sources is calculated, and on the basis of the obtained similarity, a combination of attributes which are considered to be equivalent to one another is extracted. The thus extracted attributes in combination are generated as an association candidate, so that it is possible to obtain a combination of attributes exhibiting high similarity there among as an association candidate. This will facilitate the establishing of association among attributes stored in separate information sources, without necessity for a detailed knowledge, investigation, or confirmation, of numerous attributes composing each information source. Hence, it becomes easy to associate/integrate information sources, so that user convenience is improved, and so that the time and costs required for such investigation and confirmation is successfully reduced.

(2) Even if any system modification is performed on the information sources, it is still easy to generate association candidates for attributes of the modified information sources. Hence, if system modification or version up is performed in the information sources, it is possible to cope with such changes with no difficulties, thereby improving user convenience increased. Moreover, it is also possible to cope with changes in information quality itself with high flexibility.

(3) Since predetermined preprocessing is performed before the degree of similarity is calculated, it is possible to reduce the time duration required for generating an association candidate.

(4) The combinations of attributes are narrowed down before being subjected to similarity calculation. Since the similarity calculation is performed for such a limited number of combinations of attributes, the time required for generating association candidates is reduced.

(5) Since operations of the extracted combinations of attributes are checked, it is possible to evaluate whether or not the association is correct, thereby guaranteeing improved reliability.

(6) By performing similarity calculation based on a problem which has been input for obtaining attributes (information) which are helpful in association-making, an attribute which is analogous to the input problem is obtained, realizing improved user convenience.

(7) Since predetermined preprocessing is performed before a combination of attributes is extracted as an association candidate, it takes less time to generate an association candidate.

Other objects and further features of the present invention will be apparent from the following detailed description when read in conjunction with the accompanying drawings.

### BRIEF DESCRIPTION OF THE DRAWINGS

FIG. 1 is a block diagram schematically showing a system of associating attributes separately stored in different databases, according to one preferred embodiment of the present invention;

FIG. 2, (A) and (B), is a view indicating examples of databases which are to be associated with each other by the present system;

FIG. 3 is a view for describing a method of calculating the degree of similarity based on a pair of attributes that has already been associated with each other, according to the embodiment;

FIG. 4 is a flowchart for describing an operation of the system of the embodiment; and

FIG. 5 is a view illustrating an example of a screen image on a conventional associating apparatus.

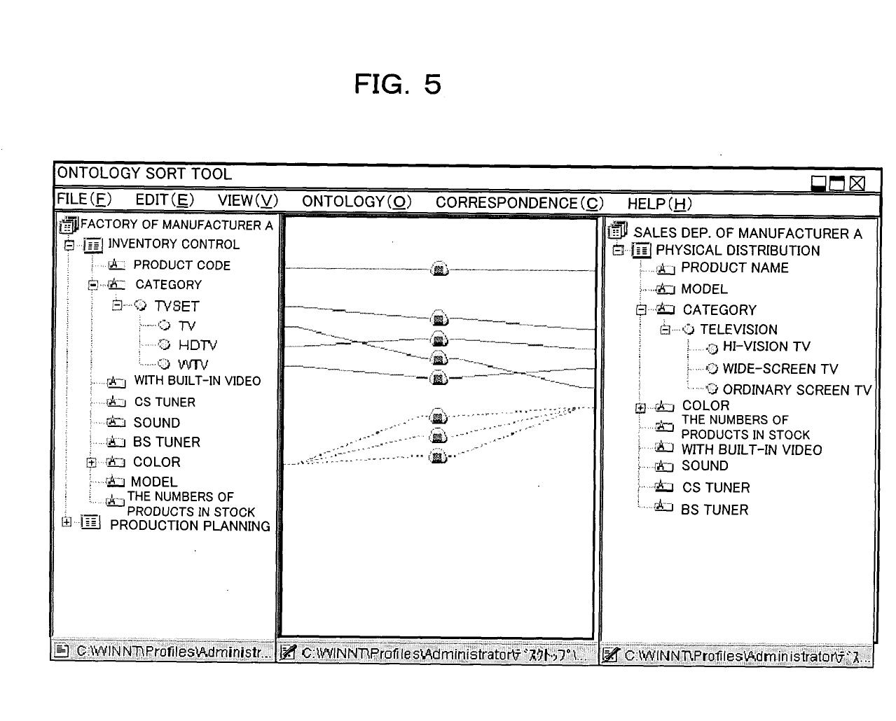

### DESCRIPTION OF THE PREFERRED EMBODIMENT(S)

One preferred embodiment of the present invention will now be described with reference to the accompanying drawings.

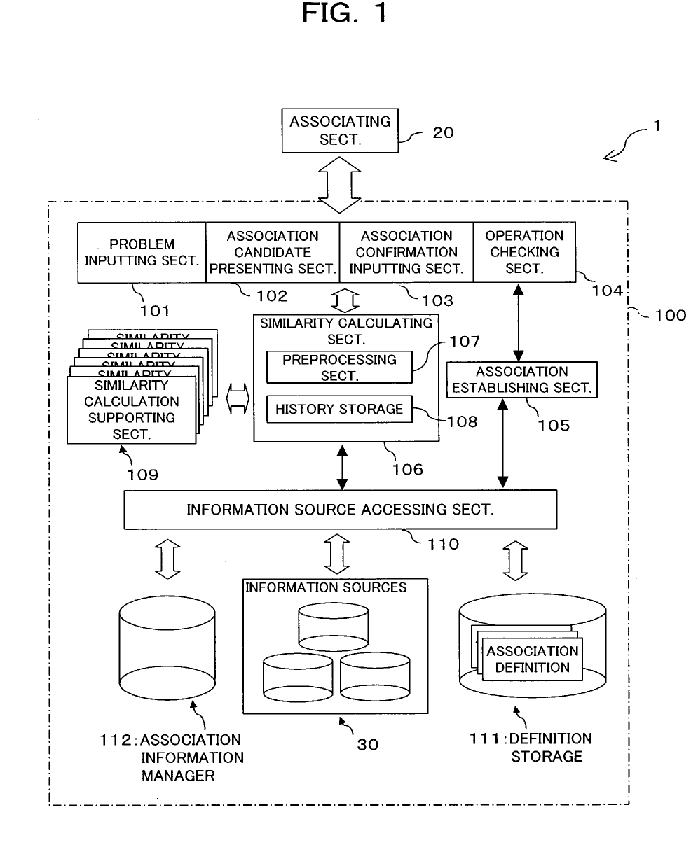

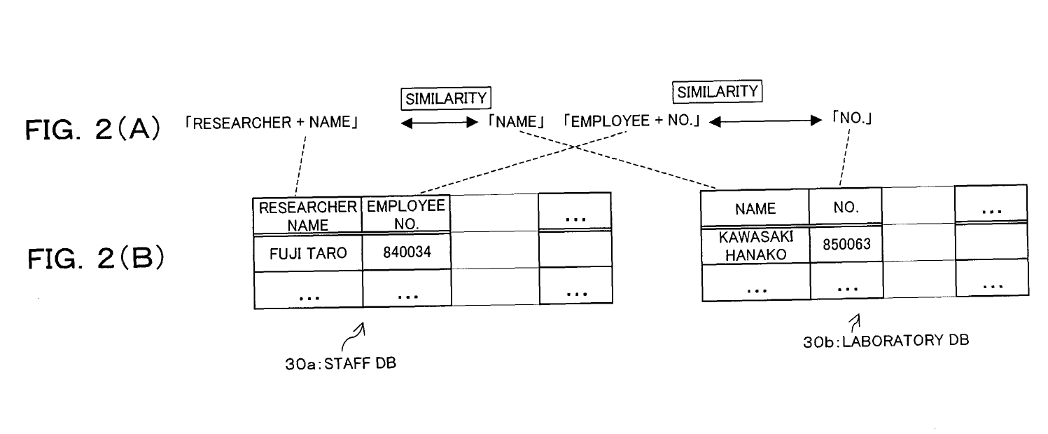

FIG. 1 depicts a construction of attributes-associating system (hereinafter simply called “associating system”) 1 of one preferred embodiment of the present invention. FIG. 2, (A) and (B), shows two example databases which are to be associated with each other by the present associating system 1. The associating system 1, which has an association candidate generating apparatus 100 and an associating section 20 as shown in FIG. 1, associates attributes separately stored in different information systems (information sources 30) The information source 30 stores information (attributes) to be associated with by the present associating system 1. For example, the information source 30 is an information system such as a database system or a structured document using a markup language like XML (Extensible Markup Language).

For instance, assuming that the information sources 30 are database systems, the associating system 1 links/integrates the different databases by associating their attributes. Referring now to FIG. 2, in one preferred embodiment of the present invention, a description will be made of an example where two databases (information sources 30), a staff DB (Data Base) 30a and a laboratory DB 30b, are to be linked/integrated.

In the following description, the information sources which are to be subjected to integration by the associating system 1 are designated as the information sources 30. In cases where an arbitrary one or the information sources (databases) are referred to, however, it will sometimes be also called “staff DB 30a” or “laboratory DB 30b”.

The associating section 20 associates information attributes separately stored in different information sources 30, based on association candidates generated by the association candidate generating apparatus 100. For example, an operator can manually links the association candidates one by one. Otherwise, such associating processing can be automated with a previously prepared computer program or the like. In the latter case, the associating processing may be carried out as batch processing.

After associating a pair of attributes (information), the associating section 20 notifies the association candidate generating apparatus 100 (association confirmation inputting section 103) of the details (results) of the association established.

The association candidate generating apparatus 100 generates a pair of information attributes, each of which is stored (dispersed) in a separate information source 30, as an association candidate. The thus generated association candidate is then output to the associating section 20. More precisely, the association candidate generating apparatus 100 compares one attribute (information) in a specific information source 30 with another attribute (information) in another information source 30, to calculate the degree of similarity between these attributes. On the basis of the comparison result (calculation result), if it is judged that the attributes analogize with each other, the association candidate generating apparatus 100 outputs the pair of attributes (information pair) as an association candidate.

In other words, such a similarity degree can serve as a measure for evaluating whether or not attributes separately stored in different information sources 30 analogize with each other. For example, assuming that score points are used to represent the similarity between a pair of attributes, the higher the score point of an attribute pair, the closer the similarity between the attribute pair.

The association candidate generating apparatus 100 then outputs a pair of attributes (information set) with a close similarity between them (scoring higher than a predetermined threshold) as an association candidate, together with the degree of similarity between them.

Concretely, the association candidate generating apparatus 100 searches dispersed information sources 30 for an attribute which is similar to an attribute “researcher name” (see FIG. 2) in the staff DB 30a. An attribute “name” in the laboratory DB 30b is then found to have a good analogy with the “researcher name”, and the association candidate generating apparatus 100 shows as such, together with the degree of similarity between the these attributes.

The association candidate generating apparatus 100, as shown in FIG. 1, has a problem inputting section 101, an association candidate presenting (outputting) section 102, an association confirmation inputting section 103, an operation checking section 104, an association establishing section 105, a similarity calculating section (similarity calculating means) 106, a similarity calculation supporting section 109, and an information source accessing section (obtaining means, extracting means) 110.

The association candidate generating apparatus 100 is realized by, for example, a computer. In the present embodiment, the concept of a “computer” includes hardware and an operation system; that is, it means hardware under control of an operation system. Further, in a case where application programs operate hardware with no need for an operation system, the hardware itself corresponds to the “computer”. The hardware should at least have a microprocessor such as a CPU (Central Processing Unit) and a means for reading out computer programs recorded in a recording medium.

The information source accessing section (obtaining means) 110 accesses information sources 30, which is to be associated with each other, to obtain attributes (information) stored in the sources 30, thereby serving as an information obtaining means. The information source accessing section 110 also stores information about information sources 30 (for example, access methods, application types, and whether or not to be linked).

Generally speaking, such information about the information source 30 is automatically registered in the information source accessing section 110, when a user inputs a method of accessing each information source 30. More precisely, the user registers a method for accessing an information source 30, and then inputs the name and the type of the information source 30.

Further, upon completion of such inputting by the user, it is preferred that a list of accessible information sources 30 existing over one and the same network, is browsed, so that all the information sources 30 on the list are subjected to the registration. After that, the user selects one specific information source 30 on the list, thereby determining whether or not the information source 30 is subjected to the registration. Furthermore, if automatic accessing is unavailable to an object information source 30, the registration processing may be manually carried out.

In addition, the registration of such access methods and the inputting of such information about the information sources 30 may be performed not in advance but as occasion arises. Another method for defining (registering) the information source 30 than such direct registration of a database, is to describe an extract instruction in a specific language unique to the information source 30, so that the definition is made in a indirect manner. In that case, information sources 30 in combination with their extraction methods may be displayed in tubular form, so that an agent can use the extract instruction.

The problem inputting section 101 is for use in inputting a problem for obtaining information which is helpful in establishing association (hereinafter also simply called the “problem”). For example, a user can directly input such a problem through an input means (not shown) such as a keyboard and a mouse, or otherwise, he can use external equipment via various types of interfaces (communication networks or buses; not shown) to input the problem, thereby realizing the problem inputting section 101.

When inputting a problem on the problem inputting section 101, a user punches a sentence, for example, “which attributes are similar to “researcher name” of the staff DB?” onto a keyboard. The thus input problem input from the problem inputting section 101 then enters the similarity calculating section 106 (or the similarity calculation supporting section 109).

In the present embodiment, such a problem may be received (input) from the associating section 20. In this case, where the problem is received from external equipment to the association candidate generating apparatus 100, the problem is input to the association candidate generating apparatus 100 via the problem inputting section 101.

As a cue for association processing, the problem in putting section 101 may present lists of attributes which are contained in the pre-registered databases (information sources 30) in the associating system 1. A user selects/inputs a specific attribute on one of those lists, and an attribute similar to the selected attribute is asked in the problem. On the attribute lists presented, attributes may be listed in order of priority, according to the similarity judged by the preprocessing section 107. Or otherwise, attributes contained in a virtual table (described later) may be presented sequentially.

The association confirmation inputting section 103 is for use in inputting confirmation of association on external equipment to the association candidate generating apparatus 100. In the present associating system 1, association-related information, which has been input from the associating section 20, is input to the association candidate generating apparatus 100 via the association confirmation inputting section 103. Additionally, the information input from the association confirmation inputting section 103 is transferred to the similarity calculating section 106.

The similarity calculating section 106 calculates the degree of similarity among the attributes, which has been obtained by the information source accessing section 110, for generating association candidates.

Here, in the present embodiment, the similarity calculating section 106 instructs each similarity calculation supporting section 109 to execute arithmetic calculation according to its algorithm, based on a problem input from the problem inputting section 101, and then obtains the calculation results. The similarity calculating section 106 collects details of the similarity calculation carried out by each of the similarity calculation supporting sections 109, and processes the calculation results in combination, thereby obtaining a total degree of similarity.

On the basis of the thus calculated similarity and similarities characteristic to various kinds of viewpoints, the similarity calculating section 106 generates association candidates corresponding to the similarities, and then transfers the generated association candidates to the association candidate presenting section 102. For example, the similarity calculating section 106 compares the similarity calculated between a specific pair (attribute set; information set) of attributes (information) with a predetermined threshold. If the calculated similarity equals or exceeds the threshold, the attribute pair is identified as an association candidate.

Further, the similarity calculating section 106 transfers association details input from the association confirmation inputting section 103 to the history storage 108 to be stored therein as a history. On the basis of the input, the similarity calculating section 106 also carries out calculation for presenting association candidates.

Such similarity calculation may be initiated by the similarity calculating section 106, upon receipt of instruction given from external equipment to the association candidate generating apparatus 100. Otherwise, part or the whole of the calculation may be carried out as preprocessing.

If preprocessing is required, the preprocessing section 107 (detailed later) is activated in response to instruction from external equipment to the association candidate generating apparatus 100, and executes all or part of the calculation. At that time, the calculation is performed separately by each of the similarity calculation supporting sections 109.

The similarity calculation supporting section 109 helps the similarity calculating section 106 in calculation, by performing part of calculation of the similarity among attributes. That is, the similarity calculation supporting section 109 carries out the similarity calculation in part. To be more specific, as to an attribute specified in the problem input from the problem inputting section 101, the similarity calculation supporting section 109 calculates the degree of similarity between the attribute and other attributes similar to the former. As the calculation result, the attributes are ranked according to the similarity, or the attributes are given score points indicating the similarity. The calculation result is returned to the similarity calculating section 106.

In the present embodiment, there are provided six similarity calculation supporting sections 109, one for each of the following six types of similarity calculation algorithms: similarity in (1) attribute name; (2) attribute type; (3) distribution of attribute values; (4) distribution of character elements (graphemes) constituting attribute values; (5) distribution of the sizes (string lengths) of attribute values; and (6) attribute value. A description will be given hereinbelow of similarity calculation algorithms employed in the associating system 1.

(1) Similarity of Attribute Name:

This method compares the names of attributes in one database (information source 30) with those in another database (information source 30) to calculate the similarity (similarity degree) among them. In this method, evaluation is made as to whether the attribute names are identical, and moreover, the character strings of each attribute name are divided into two or more character groups, and the similarity among the attributes are evaluated with respect to the divided character groups. As in the example of FIG. 2, (A) and (B), the attribute name “researcher name” of the staff DB 30a is divided into two character groups, “researcher” and “name”, and the similarity between these groups and the attribute name “name” of the laboratory DB 30b is then evaluated.

As a technique for dividing a character string, a morphological analysis technique is available, and otherwise, a method of extracting only terms, such as “name” and “number”, which directly describe the attributes can be employed. Here, when the similarity between “mei” (meaning “name” in Japanese) and “shi-mei” (meaning “full name” in Japanese) is calculated, a dictionary for similarity evaluation can be used. In the present embodiment, with combined use of these techniques, it is possible to calculate various levels of similarity, not limited to complete agreement between attribute names.

(2) Similarity of Attribute Type:

Generally speaking, the types of attributes are defined in databases (information sources). Such attribute types (for example, date, number, or character string) describe the characteristics of the attributes. Additionally, a precision property can also serves as an attribute type. It is evaluated whether or not object attributes are similar in attribute type, so that the similarity among the attributes can be calculated. For example, if two attributes share a common attribute type of “date”, these two are recognized to be similar with each other.

(3) Similarity of Distribution of Attribute Values:

This is a method in which attributes in separate databases (information sources) are compared in distribution of their attribute values to calculate the similarity (similarity degree) among the attributes. For example, provided attributes each containing varying numerical values are compared, ranges (from the minimum to the maximum) of attribute values in object attributes are compared with one another. Further, the attributes may also be compared in terms of the mean or the distribution of their attribute values. On the basis of such comparison result, the similarity among the attributes in the separate databases is calculated. Here, in the presence of a blank record with no numerical data stored therein, the frequency at which such blank records are defined may also be utilized as an indicator for similarity evaluation.

(4) Similarity of Distribution of Character Elements of Attribute Values:

In this method, attributes in separate databases (information sources) are compared in terms of distribution of character elements composing the attribute values of the attributes, to calculate the similarity (similarity degree) among them. More concretely, each of the attribute values stored in the attributes is separated into character elements (graphemes), and the similarity in distribution, such as the maximum, the minimum, and the average of the character elements, is investigated. On the basis of the investigation result, the similarity among the attributes in the separate databases is calculated.

(5) Similarity of Distribution of the Sizes of Attribute Values:

In this method, attributes in separate databases (information sources) are compared in terms of distribution of the sizes of their attribute values, to calculate the similarity (similarity degree) among them. For example, if the attribute values stored in object attributes are character strings, comparison of distribution of such attribute sizes is effective for evaluating the similarity among the attributes, because the sizes (lengths) of the character strings significantly depend on what kind of information is store in the attributes. More precisely, utilizing the sizes of the attribute values as numerical values, the similarity in distribution, such as the maximal, minimal, and average values, is investigated. On the basis of the investigation result, the similarity among the attributes in the separate databases is calculated.

(6) Similarity of Attribute Values:

This method directly compares attribute values stored in different attributes of separate databases (information sources). It examines the percentages at which the attribute values stored in the different attributes agree, to calculate the similarity among the attributes. In the present calculation method, if all the attributes of the information sources 30 were subjected to the comparison, it would take a long time to complete the comparison. Therefore, a preprocessing section 107 may take in charge of carrying out the comparison as preprocessing. Otherwise, other types of similarity calculation may carried out in advance, thereby narrowing down the attributes to be subjected to this direct type of similarity calculation. As a result, the similarity calculation can be carried out with improved efficiency.

In the present associating system 1, the above similarity calculation of several types, which is carried out by the similarity calculation supporting section 109, includes two kinds of processing: one is preferred to be carried out in real time; the other is preferred to be carried out as preprocessing (described later) by a preprocessing section 107.

Among various kinds of similarity calculation processing carried out by similarity calculation supporting sections 109, the processing (calculation or the like) that is required to be executed every when comparison (matching) of every attribute is performed, should be carried out in the following manner. That is, if any processing can be only once performed before the matching of attributes, without the necessity for repeating the processing at every matching, such processing is preferred to be performed as preprocessing. As a result, the same calculation is no longer required to be repeated at every matching process, thus causing improved efficiency.

Concretely, characteristic features of attributes in each database (information source 30) which is registered to be subjected to associating processing, are extracted separately for each algorithm (first stage), and attribute values stored in such extracted attributes are compared with one another, thereby narrowing down, to a degree, candidate attributes to be associated with an object attribute (second stage). The second-stage narrowing-down processing should not be performed on all the probable combinations of attributes, but only on limited combinations of attributes which have been found out by roughly estimating the similarity of each attribute with other attributes according to the aforementioned features extracted on the first stage.

In other words, except for such part of the processing as is requiring a computer program's or an operator's confirmation, the remaining part of the processing can be performed previously as preprocessing. In the present embodiment, a preprocessing section 107 of a similarity calculating section 106 performs the preprocessing, or it instructs the similarity calculation supporting sections 109 to do so.

As has been described under item (6) of the attribute similarity calculation, if time-consuming processing due to a number of combinations of attributes to be processed is performed, the preprocessing section 107 instructs the similarity calculation supporting sections 109 to carry out preprocessing for narrowing down the combinations, thereby reducing the time duration required for competing later processing.

Here, the preprocessing section 107 may instruct the similarity calculating section 106 and the similarity calculation supporting sections 109 to calculate the degrees of similarity among the attributes of all of the databases (information sources 30).

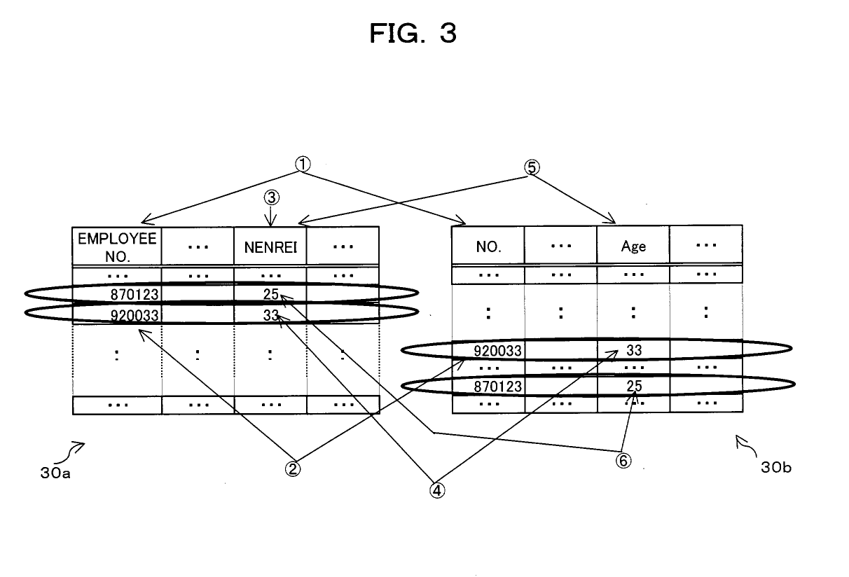

Provided a pair of attributes (information), each stored in separate databases (information sources 30), have already been associated with one another, the similarity calculating section 106 calculates the similarity among other attributes with respect to the same instance (entity) stored in the databases. FIG. 3 is a view for describing a similarity calculation method to be carried out in an associating system 1 of one preferred embodiment of the present invention. In this method, the similarity is calculated based on a pair of attributes which has already been associated with each other. FIG. 3 shows an example where association is established between the staff DB 30a and the laboratory DB 30b. The attribute “employee No.” of the staff DB 30a has already been associated with the attribute “No.” of the laboratory DB 30b (see arrow 1 in FIG. 3).

From the information sources 30 (the staff DB 30a and the laboratory DB 30b), between which association of attributes has already been made, the similarity calculating section 106 obtains instances (entities, or records), one from each of the information sources 30, which instances store an identical (or approximate) attribute value in those associated attributes. In the example of FIG. 3, the similarity calculating section 106 obtains from the staff DB 30a an instance having an attribute value of “920033” in the attribute designated as “employee No.”, while it obtains from the laboratory DB 30b an instance having the same attribute value, “920033”, in the attribute designated as “No.” (see arrow 2 in FIG. 3).

After that, as to one (in this example, “nenrei” (meaning “age” in Japanese); see arrow 3 in FIG. 3) of the other remaining attributes of the instance in the staff DB 30a, the similarity calculating section 106 evaluates whether or not any of the attribute values stored in the corresponding instance in the laboratory DB 30b is the same as the attribute value stored in “nenrei” of the staff DB 30a. Here, if the evaluation result is positive (see arrow 4 in FIG. 3), there is a high probability that these attributes match each other (see arrow 5 in FIG. 3).

The similarity calculating section 106 then obtains instances storing attribute values in “nenrei” and “age” from the staff DB 30a and the laboratory DB 30b (information sources 30), respectively. The attribute values of the attribute “nenrei” stored in the thus obtained instances from the staff DB 30a and the attribute values of the attribute “age” stored in the thus obtained instances from the laboratory DB 30b, are compared to evaluate their agreement (see arrow 6 in FIG. 3). If, for example, the frequency at which the attribute values in “nennei” and those in “age” match exceeds a predetermined threshold, it is judged that these two attributes are high in similarity between them. With this procedure, it becomes possible to find out association candidates more effectively.

In accordance with association determined (input) by the associating section 20, the association establishing section 105 actually links (associates) a specific attribute (information) of an information source 30 with a specific attribute of another information source 30. During operation checking (simulation) by an operation checking section 104, the association establishing section 105 links such attributes, in response to instructions given by the operation checking section 104, and then passes the association results to the operation checking section 104. This makes it possible to check (simulate) whether a link could function correctly with use of actual information sources 30. Further, the association establishing section 105 carries out the associating of attributes (information) between information sources 30, so that, when the similarity calculating section 106 performs similarity calculation, as has been described above, based on a pair of attributes which have already been associated with one another, it is allowed to utilize the association result obtained by the association establishing section 105.

The association candidate presenting section 102 presents association candidates specified by the similarity calculating section 106 to the outside of the association candidate generating apparatus 100. In the present embodiment, the association candidate presenting section 102 notifies the associating section 20 of the association candidates. For example, assuming a user carries out associating processing through the associating section 20, if the user selects an attribute as a subject for associating processing, the association candidate presenting section 102 presents association candidates which could be associated with the subject attribute.

It is to be noted that the presentation of association candidates by the association candidate presenting section 102 should by no means be limited to the above, and there may also be presented such attributes as can serve as a cue for users to start associating processing. For example, a pair of attributes between which a high similarity degree is found out in preprocessing or the like, maybe presented. In another example, there may be virtually provided a table (virtual table; not shown) in which the attributes contained in the information source 30 are listed in decreasing order of similarity.

Provided the similarity among attributes has already been calculated in preprocessing by the preprocessing section 107, the association candidate presenting section 102 presents association candidates together with the calculation results (similarity degrees). If characteristic features of attributes have already been extracted in preprocessing, the association candidate presenting section 102 presents association candidates together with score points they made with respect to their characteristic feature. While comparing such feature score points, a user executes association processing in real time.

When the similarity calculating section 106 presents similarity calculation results to users, it can show a ranking of total scores which are calculated in combination with the similarity degrees (score points) set by the similarity calculation supporting section 109, and it can also show the similarity degrees exceeding a predetermined threshold together with their descriptions.

Users may customize similarity accumulation of the similarity calculating section 106. Further, it is preferred that features of data and users' intention are obtained while the users are performing association processing, so that such obtained information can be reflected on the setting of similarity, thereby optimizing the similarity accumulation.

Further, when presenting two or more association candidates to users as the calculation results, the association candidate presenting section 102 shows candidates of particularly high similarity one by one, in decreasing order of similarity. Moreover, several of other association candidates may be shown in a screen window in decreasing order of similarity, so that it is prevented to occur that a great number of association candidates are presented to the users at the same time, and so that the users can recognize a good association candidate with no delay which is high in similarity and thus is also high in probability of being a subject of association.

Furthermore, if the information source 30 is a database having a tubular form, the association candidate presenting section 102 can show an attribute list which lists the attributes composing a database. Such attribute lists are arranged side by side in a display screen, and an attribute on one attribute list and an attribute on another attribute list, between which there is high similarity, are connected with each other using a line or the like, thereby making it easy for users to establish attribute association. Generally speaking, if separate databases contain any similar attributes, they are often similar to each other in terms of their tubular forms, and hence, the foregoing method is considered effective for associating databases.

As to attributes in one and the same pair of databases, in particular, users have already taken notice of such attributes. It will thus be effective if the associating of the attributes is carried out simultaneously, because the user's concentration is well sustained.

Further, as to databases between which some of the attributes have already been associated with, it is highly probable that any other attributes can also be liked.

Accordingly, in the present embodiment, upon completion of association-making for an attribute of an object database, the association candidate presenting section 102 presents association candidates for another one of the attributes of the object database.

Further, if a user makes a change in attribute association, it is preferable that all the association candidates, except for the one which has been changed by the user, are re-calculated with respect to their similarity.

Still further, it is preferable that the association candidate presenting section 102 presents association candidates together with descriptions (for example, “domain-matched”, or others) which follow algorithms of the similarity calculation supporting section 109.

Furthermore, it is also preferable that instances of each information source 30 are visually shown on a screen display or the like, for the purpose of users' confirmation. As a result, it becomes possible for the users to decide the properness of the association to be made, thereby improving users' convenience.

When associating attributes between two (a first and second) databases, the association candidate presenting section 102 may present attributes of a third database as association candidates, which database contains similar attributes to those of one (here, the first database, for convenience of description) of the first and the second databases. This is because it is possible that attributes of the third database serves as association candidates for the other one (the second database) of the above two databases.

Here, in this method, the association candidate presenting section 102 presents association candidates not only when users consider association candidates but also at any time, later, when the users attempt to perform association-making.

The association candidate presenting section 102 monitors the flow of attribute association performed by a user, and investigates the tendency of the user's operation. In accordance with the tendency, association candidates matching the tendency may be assigned higher priority. For example, if the user shows a tendency to associate ID-related attributes with high priority, the association candidate presenting section 102 presents such ID-related attributes with high priority, thereby improving the workability of the user.

The definition storage 111 holds an association definition, which is a result of the associating of an association candidate that has been generated by the association candidate generating apparatus 100. The definition storage 111 records such association definitions for the purpose of sharing the definitions with other systems that use the association candidates generated by the association candidate generating apparatus 100.

The association information manager 112 stores and manages a correspondence table (on which postal codes and their corresponding addresses, for example, are listed in association with one another) for use in association-making, and it also stores and manages a history of various kinds of processing performed in the association candidate generating apparatus 100.

The operation checking section 104 instructs the association establishing section 105 to simulate an actual operation of an association candidate using the same library and definition as those that will be used at run time, in order to evaluate whether or not a pair of attributes generated as an association candidate actually has a relationship between them.

It is possible for users to do input for checking attribute association on an external apparatus to the association candidate generating apparatus 100, such as an associating section 20. On the association candidate generating apparatus 100, the operation checking section 104 receives such input, and the association establishing section carries out associating processing. The association results are then returned to the external apparatus.

Since the associating system 1 (association candidate generating apparatus 100) instructs the operation checking section 104 to perform a simulation, it is possible to proceed with association while accessing two or more databases simultaneously for checking the integration of the association results. With this construction, it is possible for users to check whether or not the defining of association is being performed successfully, thereby improving the accuracy of association candidates generated by the association candidate generating apparatus 100.

Here, if it is required to use the above correspondence table for making association, the operation checking section 104 obtains such a correspondence table from the association information manager 112, and it carries out a simulation for an association candidate with use of the correspondence table.

The simulation of the operation checking section 104 is preferred to be close to an actual operation of the present system as much as possible. However, difference in access procedure between direct access to databases and indirect access made via a distributed system, such as an agent, can sometimes cause the simulation to differ from the actual operation.

On the other hand, during the early stages of development of a distributed system, it would become a burden of a user if the present system is constructed in advance before assess is made to databases via the distributed system, because it takes much time to check operations, and also, because it is compelled to develop the system before specifications of the system are determined.

Hence, in the present embodiment, it is possible for the operation checking section 104 to realize both of the following methods: directly accessing each information source 30; accessing each information source 30 via a distributed system such as an agent, which is a method closer to actual execution circumstances than the former.

During the process of developing the system of the present invention, the operation checking section 104, instead of the actual system, simulates association candidates, so that system conversion can be smoothly performed, and so that a result of access via the distributed system can be compared with a result of direct access.

Further, in the associating system 1, for the purpose of allowing both the distributed system and the direct accessing to perform the same processing, the associating system and the agent shares the same access definitions to databases and the same association definitions.

In the present associating system 1, the aforementioned problem inputting section 101, association candidate presenting section 102, association confirmation inputting section 103, and operation checking section 104 function as an interface to communicate with the associating section 20.

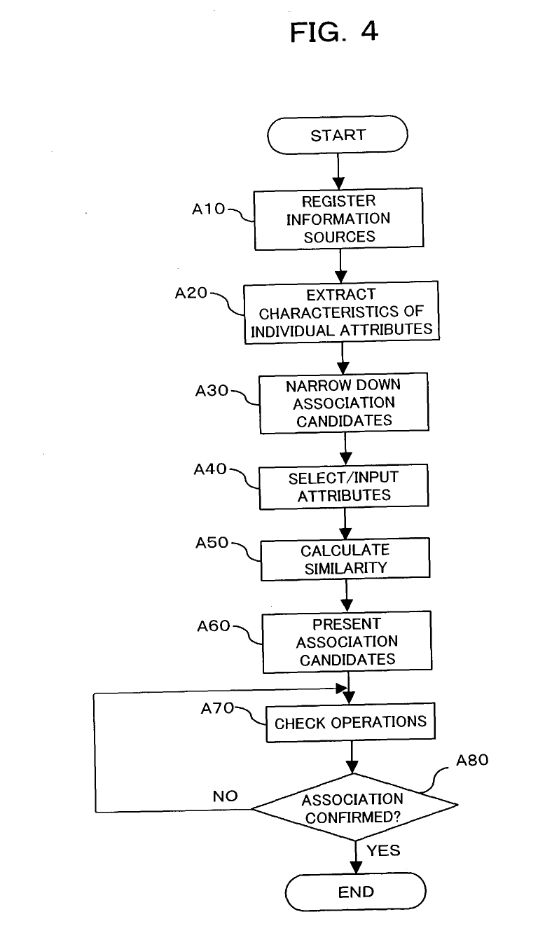

Operations of the associating system 1 of one embodiment of the present invention, having a construction as has already been described, will now be described hereinbelow with reference to the flowchart (step A10 through step A80) of FIG. 4.

Attributes (information) to be associated with by the associating system 1 are distributed among separate information systems (databases: information sources 30). Thus, a user first registers attributes relating to each information source 30 which is to be subjected to association or integration (step A10).

In the associating system 1, this registration processing is automatically performed when the user inputs an access method to the information sources 30. Thus, the user registers an access method first, and then inputs comments, such as the names and the types of the information sources 30, as necessary.

In the association candidate generating apparatus 100, the preprocessing section 107 of the similarity calculating section 106 obtains attributes composing databases (information sources 30) to be subjected to association/integration, and then characteristic features of those attributes are extracted (step A20; attribute obtaining step). On the basis of the extracted features, which has been extracted on step A20, attributes which are to be candidates for association are narrowed down (step A30). Here, in the associating system 1, these steps A10 through A30 are carried out as preprocessing.

The user inputs a problem for obtaining information (attributes) which are helpful in associating attributes, through a keyboard or the like (problem inputting section 101, associating section 20). That is, the user inputs or selects an attribute with which an attribute of another database is to be associated (step A40).

In the association candidate generating apparatus 100, the similarity calculating section 106 and similarity calculation supporting section 109 calculate the similarity between the input attribute and the attributes in the other databases, based on varying algorithms (step A50; similarity calculating step, preprocessing step). At that time, if the preprocessing section 107 carries out the similarity calculation as preprocessing, the step A50 can be omitted.

Next, the similarity calculating section 106 identifies the attributes that exhibit high similarity to the input attribute entered in step A40, as association candidates, which are then presented by the association candidate presenting section 102 (step A60; extracting step, outputting step).

The user selects an specific candidate from the presented ones, and checks the operation of the selected association candidate (step A70). That is, the same libraries and definitions as those that are used at run time, are used to simulate actual operations, thereby realizing operation checking.

On the basis of the result of the operation checking, the user evaluates whether or not the object association candidate can be actually associated with the attribute which was selected as a problem (step A80). If the evaluation result is positive (the YES route of step A80) the processing ends. Otherwise, if the evaluation result is negative (the NO route of step A80), the processing returns to step A70.

In this manner, with the associating system 1, it is easy to obtain association candidates which are specified according to the similarity among attributes each stored in separate databases (information sources 30), so that association/integration of databases (information source 30) can be facilitated.

That is, by selecting a pair of attributes to be associated with each other from the extracted association candidates which have been extracted based on the degree of similarity, the attributes can be easily associated with one another, without necessity for knowledge, review, or confirmation of details of an numerous attributes composing each information source 30, so that user convenience is increased, and so that a time period and costs for the above review and confirmation are reduced.

Further, even if any system modification is introduced in information sources 30, it is still easy to generate association candidates from attributes in the modified information sources 30. Hence, if system modification or version up is performed in the information sources 30, it is possible to absorb the changes easily, so that user convenience is increased. Moreover, it is also possible to cope with changes in information quality itself with high flexibility.

Still further, with the operation checking section 104 and the association establishing section 105, it is possible to simulate operations of association candidates, so that generated associate candidates can be investigated whether their association is proper or not, thereby realizing improved reliability.

The preprocessing section 107 may conduct specific preprocessing other than the processing which requires confirmation by a program or a user, so that the time required for completing the processing can be reduced, thereby improving user convenience.

The present invention should by no means be limited to the above-illustrated embodiment, and various changes or modifications may be suggested without departing from the gist of the invention.

For example, in the foregoing embodiment, the description was made on a case where two information sources 30 (staff DB 30a and laboratory DB 30b) are associated with each other. The number of information sources 30 to be associated with should by no means be limited to two, and three or more information sources 30 can be associated with one another. At that time, the three or more information sources 30 may be linked simultaneously. Otherwise, just two of the information sources 30 are selected to be linked, and this process is repeated for all the information sources 30.

Further, in the aforementioned embodiment, the information sources 30 to be associated/integrated were databases (staff DB 30a and laboratory DB 30b). The present invention should by no means be limited to this, and structured documents employing markup languages such as XML are also applicable as information sources 30.

Still further, in the above embodiment, there were provided six similarity calculation supporting sections 109, one for each type of algorithm of similarity calculation. The present invention should by no means be limited to this, and any other algorithm can be used, and part of the above algorithm may be unused.

What is claimed is:

1. An apparatus for generating an association candidate for use in associating a plurality of information sources each storing entities, each entity storing one or more attributes, said apparatus comprising:
(a) means for obtaining attributes, one from each of the plurality of information sources;
(b) means for calculating a degree of similarity among the attributes which have been obtained by said obtaining means (a);
(c) means for extracting, as said association candidate, a combination of attributes which are assumed to be equivalent to one another, according to the degree of similarity among the last-named attributes, which similarity degree has been obtained by said calculating means (b); and
(d) means for outputting the combination of attributes, which has been extracted by said extracting means (c).

2. An apparatus as set forth in claim 1, wherein said calculating means calculates the degree of similarity among the attributes, based on their likeness in designations given to the attributes.

3. An apparatus as set forth in claim 1, wherein said calculating means calculates the degree of similarity among the attributes, based on their likeness in terms of distribution of attribute values stored in the attributes.

4. An apparatus as set forth in claim 1, wherein said calculating means calculates the degree of similarity among the attributes, based on their likeness in terms of distribution of character elements constituting attribute values stored in the attributes.

5. An apparatus as set forth in claim 1, wherein said calculating means calculates the degree of similarity among the attributes, based on their likeness in terms of distribution of string lengths of attribute values stored in the attributes.

6. An apparatus as set forth in claim 1, wherein said calculating means calculates the degree of similarity among the attributes, based on their likeness in attribute type.

7. An apparatus as set forth in claim 1, wherein said calculating means calculates the degree of similarity among the attributes, based on a rate at which attribute values stored in the attributes agree.

8. An apparatus as set forth in claim 1, further comprising preprocessing means for performing predetermined preprocessing before said calculating means calculates the degree of similarity among the attributes.

9. An apparatus as set forth in claim 8, wherein said preprocessing means performs predetermined preprocessing before said extracting means extracts the combination of attributes.

10. An apparatus as set forth in claim 8, wherein:
said preprocessing means narrows down the combinations of attributes which are to be subjected to the similarity calculation carried out by said calculating means; and
said calculating means performs the similarity calculation on the last-named combinations of attributes, which has been narrowed down by said preprocessing means.

11. An apparatus as set forth in claim 1, wherein, if a combination of attributes, each attribute being stored in the individual information source, is already associated with one another, said calculating means (1) compares entities which have attribute values in the associated attributes, each of said entities being stored in the individual information source, and (2) calculates, based on a degree of similarity among said entities, a degree of similarity among other remaining attributes.

12. An apparatus as set forth in claim 1, further comprising means for checking an operation of the combination of attributes, which has been extracted by said extracting means.

13. An apparatus as set forth in claim 1, further comprising means for inputting a problem for obtaining information which are helpful in associating the attributes,
said calculating means calculating the degree of similarity among the attributes based on said problem, which has been input by said inputting means.

14. A method for generating an association candidate for use in associating a plurality of information sources each storing entities, each entity storing one or more attributes, said method comprising the steps of:
(a) obtaining attributes, one from each of the plurality of information sources;
(b) calculating a degree of similarity among the attributes which have been obtained in said obtaining step (a);
(c) extracting, as the association candidate, a combination of attributes which are assumed to be equivalent to one another, according to the degree of similarity among the last-named attributes, which similarity degree has been obtained in said calculating step (b); and
(d) outputting the combination of attributes, which has been extracted by said extracting step (c).

15. A method as set forth in claim 14, wherein in said calculating step, the degree of similarity among the attributes is calculated based on their likeness in designations given to the attributes.

16. A method as set forth in claim 14, wherein in said calculating step, the degree of similarity among the attributes is calculated based on their likeness in terms of distribution of attribute values stored in the attributes.

17. A method as set forth in claim 14, wherein in said calculating step, the degree of similarity among the attributes is calculated based on their likeness in terms of distribution of character elements constituting attribute values stored in the attributes.

18. A method as set forth in claim 14, wherein in said calculating step, the degree of similarity among the attributes is calculated based on their likeness in terms of distribution of string lengths of attribute values stored in the attributes.

19. A method as set forth in claim 14, wherein in said calculating step, the degree of similarity among the attributes is calculated based on their likeness in attribute type.

20. A method as set forth in claim 14, wherein in said calculating step, the degree of similarity among the attributes is calculated based on a rate at which attribute values stored in the attributes agree.

21. A method as set forth in claim 14, further comprising the step (e) of performing predetermined preprocessing before the degree of similarity among the attributes is calculated in said calculating step.

22. A method as set forth in claim 21, wherein in said preprocessing step (e), predetermined preprocessing is performed before the combination of attributes is extracted in said extracting step.

23. A method as set forth in claim 21, wherein:
in said preprocessing step, the combinations of attributes which are to be subjected to the similarity calculation carried out in said calculating step are narrowed down; and
in said calculating step, the similarity calculation is performed on the last-named combinations of attributes, which has been narrowed down in said preprocessing step.

24. A method as set forth in claim 14, wherein, if a combination of attributes, each attribute being stored in the individual information source, is already associated with one another, in said calculating step, (1) entities which have attribute values in the associated attributes are compared with one another, each of said entities being stored in the individual information source, and (2) a degree of similarity among other remaining attributes is calculated based on a degree of similarity among said entities.

25. A method as set forth in claim 14, further comprising means for checking an operation of the combination of attributes, which has been extracted in said extracting step.

26. A method as set forth in claim 14, further comprising the step of inputting a problem for obtaining information which are helpful in associating the attributes,
in said calculating step, the degree of similarity among the attributes is calculated based on said problem, which has been input in said inputting step.

27. A system for associating a plurality of attributes, each being stored separately in one of a plurality of information sources, each of which stores entities, each entity storing one or more attributes, said system comprising:
(a) means for obtaining attributes, one from each of the plurality of information sources;
(b) means for calculating a degree of similarity among the attributes which have been obtained by said obtaining means (a);
(c) means for extracting, as said association candidate, a combination of attributes which are assumed to be equivalent to one another, according to the degree of similarity among the last-named attributes, which similarity degree has been obtained by said calculating means (b);
(d) means for outputting the combination of attributes, which has been extracted by said extracting means (c); and
(e) means for associating the combination of attributes, which has been output by said outputting means (d).

28. A system as set forth in claim 27, wherein said calculating means calculates the degree of similarity among the attributes, based on their likeness in designations given to the attributes.

29. A system as set forth in claim 27, wherein said calculating means calculates the degree of similarity among the attributes, based on their likeness in terms of distribution of attribute values stored in the attributes.

30. A system as set forth in claim 27, wherein said calculating means calculates the degree of similarity among the attributes, based on their likeness in terms of distribution of character elements constituting attribute values stored in the attributes.

31. A system as set forth in claim 27, wherein said calculating means calculates the degree of similarity among the attributes, based on their likeness in terms of distribution of string lengths of attribute values stored in the attributes.

32. A system as set forth in claim 27, wherein said calculating means calculates the degree of similarity among the attributes, based on their likeness in attribute type.

33. A system as set forth in claim 27, wherein said calculating means calculates the degree of similarity among the attributes, based on a rate at which attribute values stored in the attributes agree.

34. A system as set forth in claim 27, further comprising preprocessing means for performing predetermined preprocessing before said calculating means calculates the degree of similarity among the attributes.

35. A system as set forth in claim 34, wherein said preprocessing means performs predetermined preprocessing before said extracting means extracts the combination of attributes.

36. A system as set forth in claim 34, wherein
said preprocessing means narrows down the combinations of attributes which are to be subjected to the similarity calculation carried out by said calculating means; and
said calculating means performs the similarity calculation on the last-named combinations of attributes, which has been narrowed down by said preprocessing means.

37. A system as set forth in claim 27, wherein, if a combination of attributes, each attribute being stored in the individual information source, is already associated with one another,
said calculating means (1) compares entities which have attribute values in the associated attributes, each of said entities being stored in the individual information source, and (2) calculates, based on a degree of similarity among said entities, a degree of similarity among other remaining attributes.

38. A system as set forth in claim 27, further comprising means for checking an operation of the combination of attributes, which has been extracted by said extracting means.

39. A system as set forth in claim 27, further comprising means for inputting a problem for obtaining information which are helpful in associating the attributes,
said calculating means calculating the degree of similarity among the attributes based on said problem, which has been input by said inputting means.

40. A computer-readable recording medium which stores a program for generating an association candidate for use in associating a plurality of information sources, each storing entities, each entity storing one or more attributes, wherein said program instructs a computer to function as the following:
(a) means for obtaining attributes, one from each of the plurality of information sources;
(b) means for calculating a degree of similarity among the attributes which have been obtained by said obtaining means (a);
(c) means for extracting, as said association candidate, a combination of attributes which are assumed to be equivalent to one another, according to the degree of similarity among the last-named attributes, which similarity degree has been obtained by said calculating means (b); and
(d) means for outputting the combination of attributes, which has been extracted by said extracting means (c).

41. A computer-readable recording medium as set forth in claim 40, wherein said calculating means calculates the degree of similarity among the attributes, based on their likeness in designations given to the attributes.

42. A computer-readable recording medium as set forth in claim 40, wherein said calculating means calculates the degree of similarity among the attributes, based on their likeness in terms of distribution of attribute values stored in the attributes.

43. A computer-readable recording medium as set forth in claim 40, wherein said calculating means calculates the degree of similarity among the attributes, based on their likeness in terms of distribution of character elements constituting attribute values stored in the attributes.

44. A computer-readable recording medium as set forth in claim 40, wherein said calculating means calculates the degree of similarity among the attributes, based on their likeness in terms of distribution of string lengths of attribute values stored in the attributes.

45. A computer-readable recording medium as set forth in claim 40, wherein said calculating means calculates the degree of similarity among the attributes, based on their likeness in attribute type.

46. A computer-readable recording medium as set forth in claim 40, wherein said calculating means calculates the degree of similarity among the attributes, based on a rate at which attribute values stored in the attributes agree.

47. A computer-readable recording medium as set forth in claim 40, further comprising preprocessing means for performing predetermined preprocessing before said calculating means calculates the degree of similarity among the attributes.

48. A computer-readable recording medium as set forth in claim 47, wherein said preprocessing means performs predetermined preprocessing before said extracting means extracts the combination of attributes.

49. A computer-readable recording medium as set forth in claim 47, wherein:
said preprocessing means narrows down the combinations of attributes which are to be subjected to the similarity calculation carried out by said calculating means; and
said calculating means performs the similarity calculation on the last-named combinations of attributes, which has been narrowed down by said preprocessing means.

50. A computer-readable recording medium as set forth in claim 40, wherein, if a combination of attributes, each attribute being stored in the individual information source, is already associated with one another, said calculating means (1) compares entities which have attribute values in the associated attributes, each of said entities being stored in the individual information source, and (2) calculates, based on a degree of similarity among said entities, a degree of similarity among other remaining attributes.

51. A computer-readable recording medium as set forth in claim 40, further comprising means for checking an operation of the combination of attributes, which has been extracted by said extracting means.

52. A computer-readable recording medium as set forth in claim 40, further comprising means for inputting a problem for obtaining information which are helpful in associating the attributes,
said calculating means calculating the degree of similarity among the attributes based on said problem, which has been input by said inputting means.
